(19) United States
(12) Patent Application Publication
(10) Pub. No.: US 2024/0065402 A1
(43) Pub. Date: Feb. 29, 2024

(54) Wheeled And Compressible Luggage

(71) Applicant: Stuart Berger, Scarsdale, NY (US)

(72) Inventor: Stuart Berger, Scarsdale, NY (US)

(21) Appl. No.: 17/861,184

(22) Filed: Jul. 9, 2022

(51) Int. Cl. A45C 13/26; A45C 5/03; A45C 5/06; A45C 5/14; A45C 7/00; A45C 15/00

(52) U.S. Cl. CPC A45C 13/262; A45C 5/03; A45C 5/06; A45C 5/14; A45C 7/0022; A45C 15/00; A45C 2013/265; A45C 2013/267; H02J 7/0042

(57) ABSTRACT

The present invention relates to an article of luggage that is configured to be conveniently rolled or wheeled about when in use as well as readily stored when empty and not in use. The luggage has wheels that are placed on the back side of the luggage, such that in use the luggage is wheeled about in a horizontal position. This position also provides use of the luggage as a cart for additional luggage or items that can be placed or stacked on the luggage while horizontal. The telescopic handle that is mounted in the back of the luggage is rotatable to an upward position when fully extended, to allow a user to ready pull and/or push the horizontal luggage. The luggage further has sides that are compressible/collapsible when not in use, to allow the height of the luggage to be reduced and therefore easier to store by occupying less space than the full size, fully expanded luggage. In addition, the luggage optionally has one or more outlets for charging portable electronic devices.

### FIELD OF THE INVENTION

This invention relates to articles of luggage in the form of suitcases or carrying cases, as commonly used by passengers or other travelers for the transportation of clothing and personal effects.

### BACKGROUND OF THE INVENTION

Luggage or carrying cases typically are configured as a rectangular, box-like case having a top and bottom side and four side walls. Historically, luggage was literally lugged or carried from one location to another while in use to transport an individual's personal effects or belongings, such as packed clothes, toiletries, and a wide range of various items. As use of luggage by travelers became more commonplace over time, improvements have been made to luggage to help facilitate ease of use. For example, luggage will often have two handles on different sides to ease handling of the luggage. Modern luggage typically has wheels that allow the luggage to be rolled across a ground surface, such as sidewalk, airport terminal floor, and the like. Moreover, luggage typically has a telescoping handle that extends from the luggage to enable an individual to more comfortably hold onto and control a piece of luggage while it is wheeled across a ground surface.

Despite the improvements made to luggage over time to make use and transportation of luggage more convenient for travelers and passengers, there are still issues that can make luggage inconvenient or frustrating to not only use but also to store when not in use. For example, most wheeled, rectangular luggage is designed for a piece of luggage to ride upright or vertical on the wheels, such that the wheels are attached across a narrower portion of the luggage characterized by the height and width of the luggage. In this manner, the length or longest dimension of the luggage is upright. While this configuration may appear convenient to use, it has its drawbacks. An upright, rectangular case with weight rather equally distributed across the case is typically somewhat top heavy, yielding the luggage prone to falling or easily being tipped or toppled over.

In addition, an individual will typically pack a suitcase with the case positioned horizontally on its back, with a flap or upper luggage piece designed to open to fully expose the interior of the luggage to facilitate packing of the case. However, once packed, the luggage will be rotated upward in a vertical position for transport, especially since most luggage has wheels mounted on a bottom, narrower side of the luggage. Thus, the contents, which were packed in a horizontal position, are now held in an upright, vertical position, making them prone to shifting within the luggage as it is wheeled about in an upright position.

Another inconvenience with luggage is that when not in use, the luggage occupies a significant volume of space, making it inconvenient to store when empty and not in use. For example, large suitcases can reach upwards of 13 inches high×22 inches wide×32 inches long (or more). Storage of empty suitcases while not in use accordingly requires significant space in a closet, garage, attic, or other storage space.

Given the limitations of currently available, typical luggage, there remains a need for luggage that is both more convenient to roll/transport from one location to another, and to store when empty and not in use. The presently disclosed luggage invention provides a solution to these needs.

### SUMMARY OF THE INVENTION

Provided herein is luggage that can be conveniently rolled from one location to another across a ground surface, and that can be conveniently stored when not in use. The luggage advantageously has wheels that are mounted on the back or bottom side of the luggage along the longest dimensions of the length and width of the luggage. The wheels therefore facilitate transportation of the luggage in a horizontal orientation, whereby the weight of the luggage is distributed across the luggage horizontally, such that the luggage is not prone to falling or tipping over. Movement of the luggage is facilitated by a telescoping handle that extends out from the back/bottom side of the luggage and rotates upward so that the handle is at a convenient height for use by an individual when walking the wheeled luggage from one location to another.

An article of luggage has described herein typically has a body having a top side, a bottom side, and one or more connecting sides between the top and bottom sides, with the body having a closure on a portion thereof for opening and closing the body. The one or more connecting sides have an articulated configuration that articulates at a midpoint in the one or more connecting sides, the midpoint located between and parallel to the top and bottom sides, to enable the luggage to be compressed when not in use. The bottom side of the luggage has three or more wheels mounted on the outer, underside of the bottom side of the luggage. The luggage includes an extendible handle housed in the bottom side of the luggage, and when fully extended out from the luggage, the handle is rotatable upward and away from the bottom side of the luggage, such that the handle is raised above the surface the luggage is positioned on to allow the luggage to be towed with the handle at a comfortable and convenient height.

The luggage is advantageously compressible when empty and not in use, whereby the height of the luggage can be compressed 20% to 60% or upwards to 80%. In this respect, the height of the luggage can be reduced to facilitate storage of the luggage by reducing the space needed to store the luggage by 20% to 60% or upwards to 80%.

The extendible handle of the luggage typically has an overall U-shaped configuration with two extending portions bridged at the ends by a hand-hold portion (where a user would place their hand). The extending portions of the handle are configured to slide in and out of tracks mounted in the bottom side of the luggage. The ends of the tracks typically are handle-receiving brackets that are configured to engage and restrain an end piece located at the inner end of each extending portion of the handle. In this manner, the inner ends of the handle are within the bottom side of the luggage at all times. The handle-receiving brackets have a hinge portion that can freely rotate when the end piece of the extending portion of the handle is engaged with the receiving bracket. In this manner, the fully extended handle can be rotated upward and away from the bottom side of the luggage such that it can be held at an angle above the ground surface that readily allows the luggage to be conveniently pulled or pushed by a user.

An additional, optional feature of the presently disclosed luggage is one or more electronic device outlets housed/built in the luggage, with the one or more outlets powered by a power bank that is also housed within the luggage.

The preceding and following embodiments and descriptions are for illustrative purposes only and are not intended to limit the scope of this disclosure. Other aspects and advantages of this disclosure will become apparent from the following detailed description.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 shows a side view of an article of luggage.

FIG. 2 shows a side view of an article of luggage with an extended handle.

FIG. 3 shows a top view of an article of luggage with an extended handle.

FIG. 4 shows a bottom view of an article of luggage with an extended handle.

FIG. 5 shows a side view of a section of an extended handle of an article of luggage.

FIG. 6 shows a top view of a section of an extended handle of an article of luggage.

FIG. 7 shows a bottom view of a section of an extended handle of an article of luggage.

FIG. 8 shows a top view of an end portion of a handle of an article of luggage.

FIG. 9 shows a top view of a receiving end for an end portion of a handle of an article of luggage.

FIG. 10 shows a side view of an article of luggage.

FIG. 11 shows a side view of an article of luggage with a partially extended handle.

FIG. 12 shows a side view of an article of luggage with a fully extended handle.

FIG. 13 shows a side view of an article of luggage with a fully extended handle that is rotated upward.

### DETAILED DESCRIPTION OF THE INVENTION

In the Summary above and in this Detailed Description, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The present invention relates to a wheeled and compressible article of luggage. As used herein, the term “luggage” is used in the ordinary sense of the word, and is synonymous with carrying case, suitcase, travel case, travel bag, and so forth. Luggage accordingly refers to an article that has a box, bag, and/or container like construction that is designed to hold personal goods/belongings such as clothes, various personal effects, and the like. A piece of luggage therefore typically has a body with a closure on a portion thereof for opening and closing the body to allow insertion and removal of articles into the luggage. The term “luggage” is derived from common, historical use in which an article of luggage was literally lugged or carried from one location to another for the transport and/or storage of personal goods. Typically, use of luggage is associated with travel, in which luggage is used to store and/or transport personal goods while traveling by automobile, bus, train, airplane, ship, and so on, and while staying at a destination away from home.

Luggage is typically sized and shaped to provide a convenient medium for the storage and transport of personal goods, such as sizes that are allowed or required for air travel. In that regard, luggage may be carried on-board, into the cabin of an airplane, or checked in for transport in the luggage or freight compartment of an airplane. In the case of carried on luggage, most airlines have volume requirements, such that luggage must fit within certain height, width and/or length requirements. Likewise, most airlines have volume and weight requirements for checked luggage, such that luggage must fit within certain height, width and/or length requirements along with certain weight requirements.

The dimensions and weight of luggage often make luggage cumbersome to move about. The presently disclosed luggage makes it more convenient for a person to both transport luggage and to store it when not in use. The transportation of the disclosed luggage is facilitated by wheels that are mounted underneath the luggage on its back side, such that the longest length and width dimensions along with the center of gravity of the luggage face and ride as close to the ground as reasonably possible, with ground clearance defined by the height of the wheels. This configuration alleviates the issue of cumbersome luggage that is prone to falling or tipping/toppling over because it is top heavy relative to the position of the wheels on the luggage. Furthermore, this configuration allows luggage to serve as a base for transporting other luggage, such that the luggage can effectively act as a cart for carrying additional luggage that can be placed or stacked upon the wheeled luggage. A key aspect of the presently disclosed luggage is a handle that telescopically extends from the luggage and rotates upward to a height that is convenient for pulling and/or pushing the luggage, either by itself or when loaded with additional items placed or stacked upon the luggage.

Another aspect of typical luggage that makes it inconvenient is the amount of storage space required to store the luggage when not in use. Luggage, such as a large suitcase designed to be checked in, can easily reach dimensions of about 13 inches high by about 22 inches wide by about 32 inches long or more with respect to each of the dimensions. An empty piece of luggage accordingly can occupy a significant amount of space. The presently disclosed luggage makes storage more convenient by providing a case that compresses or folds down when empty and not in use. The luggage compresses or folds down to about 20% to about 80% of its fully extended height, with all variations, such as 25%, 30%, 35%, 40%, 50%, 60%, 70% and virtually all dimensions included within that range. For example, a large suitcase that might be 12 inches high when fully expanded to its maximum height might compress to a height of about 3 inches, 4 inches, 5 inches, 6 inches, or any increment in-between.

The presently disclosed luggage is capable of being compressed via a hinge-like, articulated design that is typically located at the midpoint of the height of the luggage case, running the full length and width of the case. Accordingly, the articulated design or configuration articulates at a midpoint in the sides of the luggage, with the midpoint being located between and parallel to the top and bottom sides of the luggage. For example, a case measuring 30 inches long by 20 inches wide by 12 inches high when fully expanded will have a hinge-like, articulated construction that allows the side walls of the luggage to compress, hinge, fold, and so forth inward (toward the center of the luggage) to a fully folded height of about 3 to 4 to 5 to 6 inches. In one embodiment, the side walls of the luggage case will be soft sided or semi-soft sided and have a seam that runs the entire length and width of each of the side walls of the case and is located at the midpoint of the height of the luggage side walls, such that when the case is compressed, the side walls fold in at the seams toward the center of the case to allow the case to fold down to a lower, fully folded height. For example, a case that has a fully expanded height of about 12 inches may have a seam located at a midpoint 6 inches in from the top and back sides of the luggage, such that the sides can be folded in at the seam when the luggage is not in use, thereby compressing the height of the luggage to about 3 to 4 to 5 to 6 inches, depending upon the particular configuration, material used in the construction of the luggage, and so forth. In an alternative embodiment, the luggage will have a hinged, framed construction that has a rod or similar hard stick or bar-like rigid member that is located mid-point between the top and bottom sides of the luggage, such that the sides of the luggage case fold inward toward the center when compressed.

An additional, optional feature of the presently disclosed luggage is one or more electronic device outlets housed/built into the luggage, with the one or more outlets powered by a power bank or battery that is also housed within the luggage. In this manner, the luggage can conveniently provide a source for charging one or more electronic devices, such as a cell phone, tablet computer, and so on. For example, the luggage can house one or more USB ports, micro-USB ports, USB-C ports, lightening ports, and other similarly functioning ports that can be used as charging outlets to charge portable electronic devices. One or more charging ports can be mounted into the luggage such that a port is accessible on an exterior surface of the luggage or alternatively, accessible inside a compartment located on the exterior or interior of the luggage. Power to the one or more charging ports is provided by a power bank that is contained within a designated space in the luggage that is configured to hold a power bank and position it for connecting to the one or more charging ports. For example, a power bank can be contained in a pocket inside a compartment on the exterior of the luggage. The power bank can be configured to be charged while in the luggage, or alternatively, can be a portable power bank configured to be charged outside of the luggage and then inserted into the luggage when charged for use.

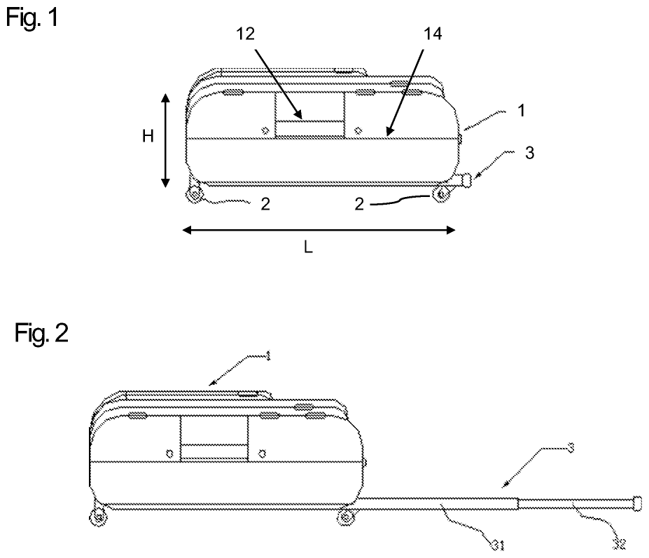

Turning to the figures, an exemplary embodiment of the presently disclosed luggage is shown. FIG. 1 shows a side view of an embodiment of the fully expanded, full height luggage 1 lying down with its handle 3 compressed or retracted into the luggage, with two of the four wheels 2 pictured. FIG. 2 shows an embodiment of the luggage 1 lying down with its handle 3 fully, telescopically extended, with fully extended portions 31 and 32. The narrower portion 32 telescopes out from the wider portion 31, which in turn slides out from the body of the case of the luggage 1. FIGS. 1 and 2 show the luggage 1 from a side view, such that the length/longest side (L) of the luggage 1 as well as the height (H) of the luggage 1 is visible. The Figures are also slightly angled to show the top side of the luggage 1. In the exemplary embodiment shown in FIGS. 1 and 2, a side handle 12 of the luggage 1 is visible. Also, the seam 14 at which the luggage 1 folds is visible.

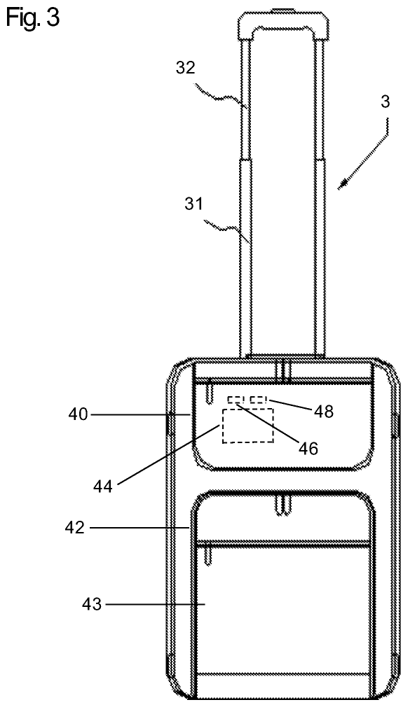

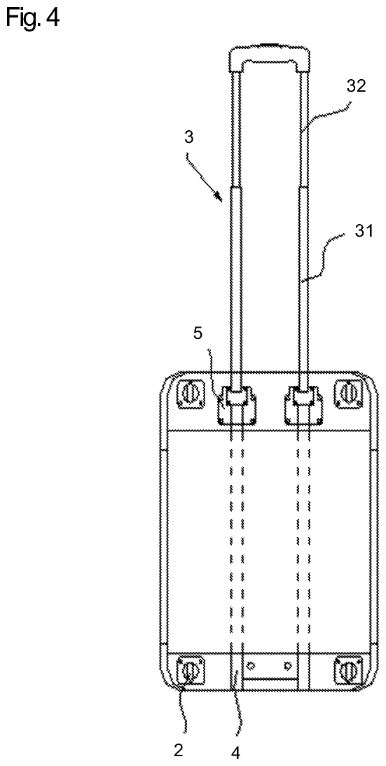

FIGS. 3 and 4 respectively show the exemplary luggage embodiment 1 from a top view and bottom view. FIG. 3 shows the luggage 1 with a fully, telescopically extended handle 3 that has an overall U or open-box shape whereby a hand-hold handle portion connects to two side, rail-like portions. The narrower side portions 32 of the handle telescope out from the wider portions 31 of the handle, which in turn slides out from the body of the case of the luggage 1. FIG. 4 likewise shows the luggage 1 with a fully, telescopically extended handle 3, with the narrower portions 32 telescoping out from the wider portions 31, which in turn slide out from the body of the case of the luggage 1. FIG. 4 further shows the slot or track 4 that the handle 3 slides into and out of, whereby the slot or track 4 as shown runs through the back of the luggage 1. FIG. 4 also shows the luggage 1 bracket mechanism 5 that the handle 3 slides through both when it is elongated and when it is compressed back into the luggage 1, as shown in FIG. 1. In addition, FIG. 4 also indicates the wheels 2 on the bottom side of the luggage 1.

FIG. 3 shows a preferred embodiment of the luggage that has exterior compartments 40, 42, and 43 that are opened and closed by a fastener, such as a zipper (as shown), snaps, hook and eye loops, and so on. As shown, compartment 43 is an exterior compartment that is layered over exterior compartment 42.

In a preferred embodiment, the luggage further contains one or more charging outlets for portable electronic devices, such as a cell phone, tablet computer, and so on, whereby the charging outlets are powered by a power bank housed in the luggage. Such charging outlets can be mounted on an exterior surface of the luggage (preferably with a cover for when not in use) or alternatively, within an exterior or interior compartment. For example, one or more charging outlets can be mounted within an external or internal pocket on the luggage, whereby an external pocket would be accessible on the exterior of the luggage, while an internal pocket would be accessible when the main, internal compartment(s) of the luggage is open. As shown in FIG. 3, exterior compartment 40 can be configured to house a power bank 44 within the compartment. Preferably, the power bank 44 is housed within a pocket or similar structure in the exterior compartment 40. Likewise, the exterior compartment 40 can be configured to house one or more charging outlets within the compartment, as exemplified by two charging outlets depicted at 46 and 48.

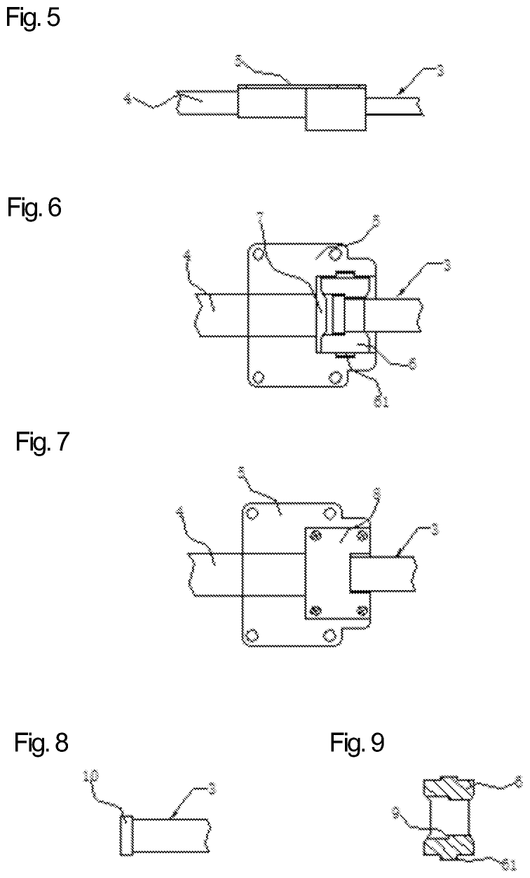

FIGS. 5-9 show portions of the handle 3 and indicate the mechanism by which it operates. FIG. 5 shows a side view of the handle 3 that is extended from the slot 4 as the handle passes through a top bracket 5 of the slide assembly. FIG. 6 shows a bottom view of the slide assembly of the luggage 1 with holes visible in the bracket 5 that provide for attachment of the bracket 5 to the body of the case of luggage 1 via a fastener, such as a rivet, screw, and so on. The handle 3 extends out from a slot or track 4 that extends across the full length of the bottom side of the depicted embodiment of the luggage 1, as shown in FIG. 4. The slide assembly includes a hinge portion 6 that limits the movement of the handle 3 as it extends from the luggage 1 so that the end 10 of the luggage handle 3 stops within the hinge portion 6. The hinge portion 6 has two tab-like portions 61 that extend from the hinge portion 6 and fit into holes in the bottom bracket 5. Once the handle 3 is fully extended from the luggage 1, the handle can rotate from being parallel with the bottom side of the luggage 1 to an upward position. The fully extended handle 3 positions the end 10 of the luggage handle 3 within the hinge portion 6, such that the handle 3 can be rotated via the hinge portion 6.

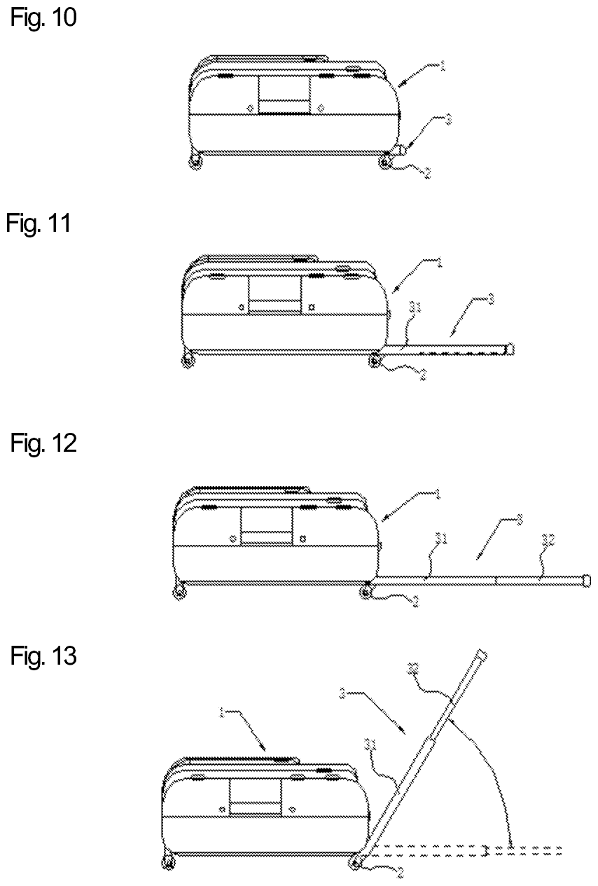

FIGS. 10-13 show side views of the luggage 1 in which the handle 3 is in different configurations; the wheels 2 located on the bottom of the luggage are also shown. FIG. 10 shows a side view of the luggage when the handle 3 is fully compressed into the body of the luggage 1. FIG. 11 shows an intermediate position of the handle 3, in which the handle 3 is partially extended, such that lower portion 31 is extended from the luggage 1. FIG. 12 shows the luggage 1 with a fully extended handle 3 such that lower portion 31 and upper portion 32 of the handle 3 are both fully extended. FIG. 13 shows the luggage 1 with a fully extended handle 3 such that upper portion 31 and lower portion 32 of the handle 3 are both fully extended and rotated upward to a position by which the luggage 1 can be readily pulled or pushed. Taken in sequence, FIGS. 10-13 show the luggage 1 as it transitions from being at rest in FIG. 10 to being in position for rolling use in FIG. 13. FIGS. 10-13 consecutively show the luggage 1 at rest with the handle fully compressed with the handle 3 compressed into the luggage 1 (FIG. 10); the handle 3 partially extended (FIG. 11); the handle 3 fully extended (FIG. 12), and the handle 3 fully extended and rotated upward (FIG. 13). A user will accordingly grab the handle 3 when the luggage 1 is at rest, pull on the handle 3 to extend it from the luggage 1, and then rotate the handle 3 to an upward position once the handle 3 is fully extended. As shown in FIG. 13, the upward position of the handle 3 will be at an angle to the bottom side of the luggage 1 and the ground surface on which the luggage 1 sits. This angle provides a convenient height of the handle 3 to enable a person/user to readily pull and push the luggage 1.

Once the luggage is in a fully operable position with the handle fully extended and rotated upward, the luggage can be readily wheeled about across a ground surface from one location to another. Furthermore, the stability of the luggage allows it to effectively function as a cart to which other luggage or other items or containers (such as a box, etc.) can be stacked. In this manner, the luggage can facilitate relocation of not only the luggage itself but other items that are placed on the luggage. Airports and other transportation centers often provide rental carts to assist passengers/travelers with movement of luggage. Such rental carts are used in a manner in which one or more pieces of luggage are placed onto the cart for rolling transport from one location to another. The presently disclosed luggage alleviates use of such a cart, since the luggage can effectively act as cart for additional luggage and items to be transported.

While the present invention has been described as having particular configurations disclosed herein, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

I claim:

1. An article of towable luggage comprising:
a body having a top side, a bottom side, and one or more connecting sides between the top and bottom sides, the body having a closure on a portion thereof for opening and closing the body;
wherein the one or more connecting sides have an articulated configuration that articulates at a midpoint in the one or more connecting sides, the midpoint located between and parallel to the top and bottom sides;
wherein the bottom side has three or more wheels mounted on the outer, underside of the bottom side;
wherein the bottom side has an extendible handle housed in the bottom side of the luggage; and
wherein the extendible handle is rotatable upward and away from the bottom side of the luggage when the extendible handle is fully extended out from the bottom side of the luggage.

2. The article of towable luggage of claim 1, wherein the body has a rectangular, box-like configuration including in which four connecting, continuously connected side walls lie between the top and bottom sides.

3. The article of towable luggage of claim 2, wherein the body has four corners and four wheels that are mounted to the underside of the body such that each corner has a single wheel mounted on the underside of the body.

4. The article of towable luggage of claim 1, wherein the extendible handle is housed in two tracks in the bottom side of the luggage, with each track having an opening at one end that the extendible handle slides through;
wherein each open end of each track is defined by a handle receiving bracket through which an extending portion of the handle slides;
wherein each extending portion of the handle has an end piece that remains within the bottom side of the luggage at all times;
wherein each handle receiving bracket is configured to engage and restrain the end piece of the extending portion; and
wherein the handle receiving bracket has a hinge portion that can freely rotate when the end piece of the extending portion is engaged with the receiving bracket.

5. The article of towable luggage of claim 4, wherein the extendible handle has an overall U-shaped configuration having a first extending portion;
a second extending portion;
and a hand-hold portion that connects the two extending portions.

6. The article of towable luggage of claim 5, wherein the extending portions of the extendible handle are telescoping portions, with each extending portion comprising two or more sub-portions that are configured to slide in and out of each other to provide an overall telescoping configuration.

7. The article of towable luggage of claim 1, wherein the articulated configuration in the one or more connecting sides comprises a seam by which the one or more connecting sides can be folded inward toward a center of the body of the luggage.

8. The article of towable luggage of claim 1, wherein luggage has a fully expanded full height that is compressible to a lower height between 20% to 80% of the full height of the luggage.

9. The article of towable luggage of claim 1, wherein the article of towable luggage further comprises one or more outlets for charging an electronic device, wherein power to the outlets is provided by a power bank housed within the article of towable luggage.

10. The article of towable luggage of claim 9, wherein the one or more outlets for charging an electronic device are located on an exterior surface of the article of towable luggage.

11. The article of towable luggage of claim 9, wherein the one or more outlets for charging an electronic device are located within an exterior compartment of the article of towable luggage.

12. The article of towable luggage of claim 9, wherein the one or more outlets for charging an electronic device are located within an interior compartment of the article of towable luggage.

13. An article of towable luggage comprising:
a body having a top side, a bottom side, and one or more connecting sides between the top and bottom sides, the body having a closure on a portion thereof for opening and closing the body;
wherein the luggage has a length and width defined by a length and width of the top and bottom sides and a height defined by a height of the one or more connecting sides;
wherein the one or more connecting sides have an articulated configuration that articulates at a midpoint in the one or more connecting sides, the midpoint located between and parallel to the top and bottom sides;
wherein the height of the luggage can be compressed via the articulated configuration;
wherein the bottom side has three or more wheels mounted on the outer, underside of the bottom side;
wherein the bottom side has an extendible handle housed in the bottom side of the luggage; and
wherein the extendible handle is rotatable upward and away from the bottom side of the luggage when the extendible handle is fully extended out from the bottom side of the luggage.

14. The article of towable luggage of claim 13, wherein the body has a rectangular, box-like configuration including in which four connecting, continuously connected side walls lie between the top and bottom sides; and
wherein the body has four corners and four wheels that are mounted to the underside of the body such that each corner has a single wheel mounted on the underside of the body.

15. The article of towable luggage of claim 13, wherein the extendible handle has an overall U-shaped configuration having a first extending portion; a second extending portion; and a hand-hold portion that connects the two extending portions;
wherein the extendible handle is housed in two tracks in the bottom side of the luggage, with each track having an opening at one end that the extendible handle slides through;
wherein each open end of each track is defined by a handle receiving bracket through which an extending portion of the handle slides;
wherein each extending portion of the handle has an end piece that remains within the track at all times;
wherein each handle receiving bracket is configured to engage and restrain the end piece of the extending portion; and
wherein the handle receiving bracket has a hinge portion that can freely rotate when the end piece of the extending portion is engaged with the receiving bracket.

16. The article of towable luggage of claim 15, wherein the extending portions of the extendible handle are telescoping portions, with each extending portion comprising two or more sub-portions that are configured to slide in and out of each other to provide an overall telescoping configuration.

17. The article of towable luggage of claim 13, wherein the articulated configuration in the one or more connecting sides comprises a seam by which the one or more connecting sides can be folded inward toward a center of the body of the luggage.

18. The article of towable luggage of claim 13, wherein luggage has a fully expanded full height that is compressible to a lower height between 20% to 60% of the full height of the luggage.

19. The article of towable luggage of claim 13, wherein the article of towable luggage further comprises one or more outlets for charging an electronic device, wherein power to the outlets is provided by a power bank housed within the article of towable luggage.

20. The article of towable luggage of claim 9, wherein the one or more outlets for charging an electronic device are located on an exterior surface of the article of towable luggage, within an exterior compartment of the article of towable luggage, or within an interior compartment of the article of towable luggage.
